(19) United States
(12) Patent Application Publication
(10) Pub. No.: US 2017/0341115 A1
(43) Pub. Date: Nov. 30, 2017

(54) Machine Tool Accessory for Swarf Removal

(71) Applicant: Wesley Ross Noll, Hollywood, MD (US)

(72) Inventor: Wesley Ross Noll, Hollywood, MD (US)

(21) Appl. No.: 15/130,865

(22) Filed: Apr. 15, 2016

(51) Int. Cl. B08B 15/04; B23Q 11/00; B23B 29/24; B23B 3/16

(52) U.S. Cl. CPC B08B 15/04; B23Q 11/005; B23B 29/24; B23B 3/165; B23B 2220/40

(57) ABSTRACT

The disclosed embodiments provide a novel and unique apparatus and method to remove swarf from a workpiece during the operation of a machine tool on that workpiece. In a preferred embodiment, a set of slanted vanes attached to a rotating part of the machine tool, when that rotating part is directed at the workpiece, clears swarf from a workpiece during machine operation without having to add any other expensive swarf removal parts, or integrate any complicated swarf removal system into the machine tool. The vanes on the rotating part, using the motion of that rotating part, provide the required force of air to blow swarf out and away from the workpiece. Among the many different possibilities contemplated, the rotating part can be a spindle, or a tool holder, or an endmill, or any other rotating part of a machine tool pointed at the workpiece during the operation of the machine. Additionally, the set of slanted vanes can attach to an inner hub fitted around or onto the rotating part and the slanted vanes can spin free of any other parts if the composition of the vanes with any metallic or non-metallic material make the vanes sufficiently stiff to provide the necessary air force on the workpiece during the operation of the machine and the high speed of the rotating part. Also, the outer edge of the slanted vanes can connect to a shroud surrounding the vanes and thus keep the slanted vanes in the required slanted position to produce the necessary force of air on the workpiece. Additionally, O-rings can be used to fit the inner hub to the rotating part and thus provide another way to create the firm and secure attachment of the machine tool swarf removal apparatus to the rotating part.

### CROSS REFERENCES TO RELATED APPLICATIONS

None.

### Field of Invention

The technology relates generally to machine tools, and more particularly to the removal of swarf or unwanted shavings or particles created during the operation of the machine tools.

### BACKGROUND

A machine tool is a machine for shaping or machining metal or other rigid materials, usually by cutting, boring, grinding, shearing, or other forms of shaping the material. A machine tool uses a tool to perform the cutting or shaping of the rigid material and the material being shaped is called a workpiece. There are a wide variety of machine tools but they all contain a way to hold the workpiece and the cutting tool. Many machine tools include one or more live tools. These are tools, typically cutting tools, perform the cutting or shaping of the workpiece. The machine tool moves the cutting tool or cutting tool and the workpiece both move, in a controlled process, performing the cutting or shaping of the workpiece, and during that cutting and shaping create discarded scraps from the workpiece are called swarf.

Many modern machine tools use computer numeric controlled (CNC) machining to increase the productivity and accuracy of manufacturing processes. A vertical machining center (VMC) is an example of a CNC machine tool. A typical VMC includes motors that move the machine bed holding the workpiece in the x-y plane and moves the spindle along the z-axis, all under the control of the machine control unit operating a computer program. The control unit controls movement of the active parts of the machine according to the instructions in this computer program creating very detailed, precise, and accurate cutting and shaping operations at high speeds. Other examples of CNC machine tools using live tooling include horizontal machining centers, various CNC router designs, turning tools with multi-axes live tooling, like horizontal and vertical lathes, screw machines, and turret lathes.

Advances in CNC and machine tool technologies have dramatically changed machining. For example, variable frequency drives have created faster and more powerful spindles. The spindle is a motor assembly that causes the rotation of the cutting tool. In a typical modern CNC machine tool, the cutting tool is held in a tool holder and the tool holder is attached to a rotating portion of the spindle. Spindle speeds have increased from 4,000 or 5,000 rpm to speeds up to or over 40,000 rpm. But these increased speeds have also created the problem of higher swarf loads (i.e., as noted, the excess chips, turnings, filings, or shavings created during the shaping of the workpiece).

All machine tools, from basic, operator driven machine tools to computer operated CNC machines, during the drilling or cutting process, create swarf. But especially with the higher speeds of the CNC machines, a critical design feature of a CNC machine is the removal of swarf during the machine's operation. Otherwise, swarf can get trapped between the cutting edge of the tooling and the workpiece. This can degrade the surface finish of the workpiece and shorten the tool life.

Some technologies have been developed to remove swarf from the cutting area during machining operations: like blowing away swarf with compressed air, flooding the workpiece with liquid coolants, or through-spindle coolant systems. But these methods require additional plumbing, pumps, filters, and other parts, and significant modifications to the machine tool. Additionally, it is difficult to point the nozzles of these systems in the right direction to consistently evacuate swarf; especially in pocket milling applications. All current swarf removal technologies suffer from one or more of these disadvantages, and as CNC milling machines reach higher and higher machining speeds, swarf loads increase, making current swarf removal methods increasingly expensive to build and integrate into the machine tool, and difficult to maintain.

Therefore, there is a need for a method or apparatus for improved swarf removal from a workpiece during the operation of any machine tool, especially in high-speed CNC machines.

### SUMMARY

The present invention provides an apparatus and method for removing swarf from a workpiece during the operation of a machine tool on a workpiece. In a preferred embodiment, a set of slanted vanes attached to a rotating part of the machine tool, directed at the workpiece, and during the operation of the machine tool the vanes connected to the rotating part blow swarf out and away from the workpiece. The method for removing swarf from a workpiece during the operation of the machine tool consists of choosing a rotating part of the machine tool directed at the workpiece, mounting a set of slanted vanes onto that rotating part, and during machine operation the rotation of the chosen rotating part with the attached slanted vanes creates an airflow on the workpiece sufficient to keep the workpiece free of swarf.

One embodiment of the invention has an inner hub attached to the rotating part of the machine tool and the slanted vanes attach to this inner hub and extend outwardly from it. Aspects of the present swarf removal invention reside in various constructions and arrangements and parts and uses of the disclosed embodiments. In embodiments of the vanes, they are composed of a wide variety of metallic or non-metallic materials, and the only requirement of the chosen material is whether it gives the vanes the required stability during high speed rotation so they don't significantly bend while creating the required air force on the workpiece. Among the many different possibilities contemplated, the swarf removal invention also connects the slanted vanes to an outer shroud surrounding the machine tool swarf removal apparatus, and this arrangement also gives the slanted vanes the required stability during high speed rotation to create the required air force on the workpiece, during the operation of the machine tool.

Another embodiment of the machine tool swarf removal apparatus is designing the apparatus as a one-piece component, such as a molded part. Still another embodiment is to cut grooves into the inner hub, fit O-rings into these grooves, and thus provide one way to firmly and securely attach the machine tool swarf removal apparatus to the rotating part of the machine tool. Other embodiments include inserting, gluing, or molding an elastomer insert into the inner hub instead of using O-rings; this would also increase the adhesion between the rotating machine tool part and the apparatus. Another embodiment of the invention is having the rotating part be the tool holder. Still another embodiment is designing the slanted vanes as part of the tool holder and thus reduce eliminate the need to maximize the adhesion between the tool holder and a separate apparatus. A further embodiment is choosing the endmill as the rotating part, and yet another embodiment choosing the rotating portion of the spindle as the rotating part.

Another embodiment attaches the slanted vanes to rigid inner hub. The inner bore of this inner hub is lined with an elastomer insert, providing increased adhesion between the rigid inner hub and the rotating part of the machine tool.

Among the many possibilities contemplated in the design and use of the machine tool swarf removal apparatus is having it operate in low-pressure coolant system, directing the vanes at the cutting area, and thus diverting coolant to that cutting area.

In further embodiments of the invention the vanes attach to an inner hub, and this inner hub forms an interference fit between the inner bore of the hub and the outer diameter of the rotating tool part. Also, another refinement of the invention is connecting the inner hub to the machine's tool holder.

Various other objects, features, aspects, and advantages of the present invention will become more apparent from the following detailed description of embodiments of the invention, along with the accompanying drawings. However, the drawings are illustrative only and numerous other embodiments are described below. Additionally, the scope of the invention, illustrated and described herein, is only limited by the scope of the appended claims.

### BRIEF DESCRIPTION OF THE DRAWINGS

Various embodiments of the invention are disclosed in the following detailed description and accompanying drawings.

FIG. 1 discloses one embodiment of a machine tool, a vertical machining center.

FIG. 2 discloses the spindle, tool holder and cutting tool of machine tool of FIG. 1.

FIG. 3 discloses one embodiment of the machine tool swarf removal apparatus.

FIG. 4 discloses one embodiment of the machine tool swarf removal apparatus connected to the tool holder of FIG. 2.

FIG. 5A discloses an embodiment of the machine tool swarf removal apparatus connected to the tool holder of FIG. 2, within the vertical milling machine tool of FIG. 1.

FIG. 5B discloses a close up view of the machine tool swarf removal apparatus embodiment in FIG. 5A, connected to the tool holder of FIG. 2, with all parts of the vertical milling machine tool of FIG. 1 set and arranged and ready for swarf removal during machine operation.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any one embodiment. The scope of the invention encompasses numerous alternatives, modifications and equivalents; it is limited only by the claims. The details set forth in this description give a thorough understanding of the invention and for the purpose of clarity, the technical details of machine tools, known by one of ordinary skill in this technical field, are not described in detail so that the invention is not unnecessarily obscured.

The disclosed embodiments of the machine tool swarf removal apparatus operates in all types of machine tools with live tooling or rotating cutting tools. Additionally, the disclosed embodiments of the swarf removal apparatus can be easily shaped and fitted to operate in CNC milling machines, CNC vertical machining centers, CNC routers, and CNC machine lathes. Additionally, the disclosed embodiments of the swarf removal apparatus work equally well in enclosed or open CNC machines. The embodiments of the machine tool swarf removal apparatus will work when attached to any spinning parts of a machine tool, when that spinning part is directed at the workpiece, and provides enough air pressure on the workpiece to clear keep it of the unwanted swarf during the operation of the machine.

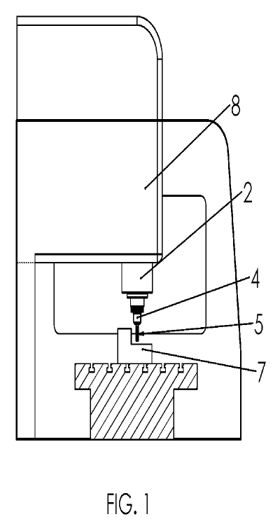

FIG. 1 discloses a vertical milling machine. A motor is enclosed within the top of the machine 8, among other things, provides the force to rotate parts of the spindle 2. The spindle 2 connects the tool holder 4 to it with a tight and secure fit, and tool holder 4 holds the cutting tool 5, also with a tight and secure fit. Thus, the spindle 2, tool holder 4, and cutting tool 5 are securely connected and operate as one unit, rotating over and into the workpiece 7. As with the other parts of the machine tool, there are a variety of tool holder designs to hold different tools at different distances from the bottom of the spindle in different ways. Any of these tool holders would be sufficient for the practice of the swarf removal apparatus as long as the swarf removal apparatus has a secure attachment to the tool holder and, as noted, during rotation creates enough force of air on the workpiece to clear it of unwanted swarf. Additionally, embodiments could have a stationary table and only the cutting tool 5 would move, or both the table and cutting tool 5 could move in concert. But none of these details of different machine tools, like the angle of the cutting tool over the workpiece, or the movements of the table and cutting tool, have any impact on the novel and unique embodiments of the swarf removal apparatus disclosed herein.

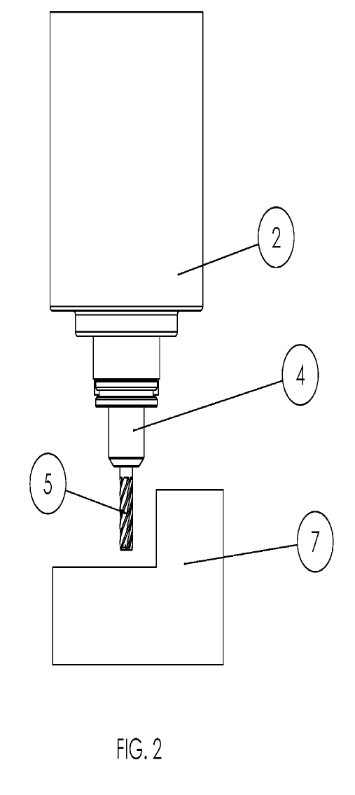

FIG. 2 discloses in greater detail the key parts of the vertical milling machine of FIG. 1. The spindle 2, tool holder 4, and cutting tool 5 of FIG. 2 are common to many machine tools and are isolated to show, in this embodiment, various ways to attach the swarf removal apparatus to a machine tool. As noted, the spindle 2, tool holder 4, and cutting tool 5 rotate and maneuver to make the required cuts into the workpiece 7, with whatever other parts of the machine tool are involved, like movement of table in concert with the rotating cutting tool 5. What is necessary for the all embodiments is a rotating machine part over, across from, or in some way directed at the workpiece, and attached to this rotating machine part is the swarf removal apparatus, as described below.

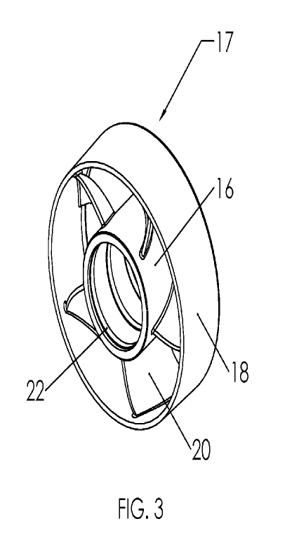

FIG. 3 discloses one embodiment of the swarf removal apparatus 17. This embodiment has slanted vanes 20, and when the swarf removal apparatus 17 is connected to a rotating part of the machine tool, directed at a workpiece 7, the swarf removal apparatus 17 provides an airflow with sufficient force to keep the workpiece 7 free of swarf. In this embodiment, the outer edges of the slanted vanes 20 connect to outer shroud 18 and the inner edges of the slanted vanes 20 connect to an elastomer insert 16, which has an inner hub 22 for fitting the device onto the rotating machine part positioned over the workpiece 7, and in this embodiment the swarf removal apparatus 17 connects to the tool holder 4.

Additionally, in one embodiment of the swarf removal apparatus 17 the slanted vanes 20 connect to a rigid inner hub 22, and the inner bore of this inner hub 22 is lined with an elastomer insert, providing increased adhesion between the rigid inner hub 22 and the rotating part of the machine tool. In another embodiment, the inner hub 22 is composed of an elastomer material and gives the inner hub 22 itself, without any inserts, the necessary tight connection between the swarf removal apparatus 17 and the rotating tool part.

Although, the outer edges of the slanted vanes 20 connect to outer shroud 18, other embodiments could do without this outer shroud 18. For example, one embodiment could use smaller slanted vanes 20 spinning at a high enough speed to clear the workpiece 7 of swarfs with no need for the outer shroud 18. The key design feature of the slanted vane device 17 is the slanted vanes 20 providing adequate air force on the workpiece 7 during machine tool operation to clear unwanted swarf out of and away from the workpiece 7 during machine tool operation.

The swarf removal apparatus 17 has many variations enabling it to connect it to any machine tool, and any rotating part directed at the workpiece 7, as long as the position and speed of the swarf removal apparatus 17, when directed at the workpiece, provides the required force of air flow to keep workpiece 7 of unwanted swarf during the machine tool's operation.

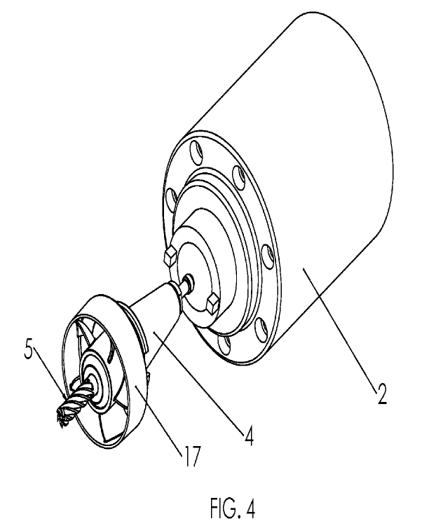

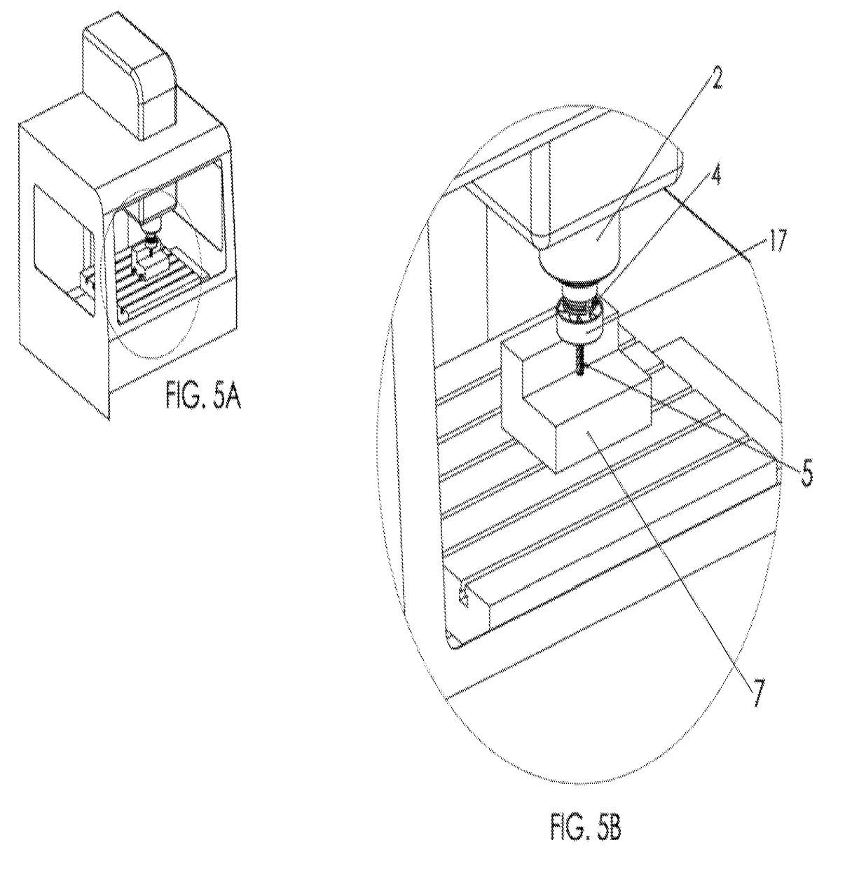

FIG. 4 discloses the swarf removal apparatus 17 connected to tool holder 4. As noted, the tool holder 4 connects to the spindle 2, and on its opposite side the tool holder 4 connects to the cutting tool 5, and, as noted, in this embodiment the swarf removal apparatus 17 connects to tool holder 4, providing the required air flow onto the workpiece 7, clearing it of swarf during machine operation. FIG. 5B shows all parts of vertical milling machine embodiment using the tool holder 4 as the machine part to connect the swarf removal apparatus 17 and during machine operation, the rotating swarf removal apparatus 17 operating over a workpiece 7, keeps workpiece 7 clear of swarf. This embodiment shows an enclosed vertical machining center FIG. 5A, but open or closed machines work equally well for swarf removal by the rotating swarf removal apparatus 17.

Also, the swarf removal apparatus 17, could be designed as a one piece injection molded component, with the inner hub 22, the slanted vanes 20, and outer shroud 18 forming a single part, or it could be created with an assembly of parts. The swarf removal apparatus 17 could be made from zytel (nylon 66) or any other nylon resin, plastic, any natural or synthetic polymer having elastic properties like elastomer, e.g., rubber, or injection molded plastic, or any suitable metal, or nonmetallic materials, as long as slanted vanes 20 have enough stability to provide the necessary air pressure to keep the workpiece 7 clear of swarf, during machine operation.

When the swarf removal apparatus 17 is designed with elastomer, and sized to fit on a machine part like the tool holder 4, it allows a novel way to install the swarf removal apparatus 17 on the correct sized tool holder, with the elastomer connecting to the tool holder 4 with the required friction to keep the swarf removal apparatus 17 securely in place during spindle 4 ramp up, operation, and shut down. Once installed and while the spindle 4 rotates the slanted vanes 20 provide the required force of air directed at the workpiece 7, and keeps workpiece 7 clear of swarf.

Using the swarf removal apparatus 17 to blow swarf out of and away from a workpiece 7 is novel and innovative. There's no need to change the existing programming when used in a CNC system because the swarf removal apparatus 17 does not interfere with any existing cutting operations or machine devices. Additionally, as noted, another embodiment of swarf removal apparatus 17 would be incorporating the slanted vanes 20 into a tool holder design, becoming part of the tool holder.

Other embodiments include the swarf removal apparatus 17 created as a single elastomer sleeve mounted or overmolded (combining two different molds into one part) into the bore of the shroud 18. The slanted vane device 17 would also allow designs that mount to the endmill, with an endmill having enough length to hold the slanted vane device 17.

Additionally, the swarf removal apparatus 17 could attach to any other suitable moving machine part, moving over the workpiece 7, with an elastomer, or other type of O-ring, installed in grooves cut into the inner hub 22, as seen in FIG. 3. These O-rings would then compress the inner hub 22 around the tool holder 4 (if the rotating part is the tool holder 4) and provide a rigid and secure connection to tool holder 4. The O-rings also allow for greater variance in the outer diameter of the tool holders, greater tolerance in the inner diameter of elastomer insert 16, and a greater selection of material to interface with the outer diameter of tool holder 4.

As noted, CNC vertical machining centers include vertical and horizontal machining centers, as well as other orientations, and other machine types like routing machines, and all of these machine types are suitable for different embodiments of the disclosed swarf removal apparatus 17. Additionally, embodiments of the swarf removal apparatus 17 could operate in lower pressure coolant systems and enhance these systems by diverting the coolant to the cutting area for far less cost than upgrades to the coolant system. The only modifications to the novel swarf removal apparatus 17 would be refitting and re-sizing the slanted vane device 17 to fit a rotating part of the coolant system directed at workpiece 7.

As noted, the disclosed embodiments are illustrative, not restrictive. While specific configurations of the swarf removal apparatus 17 have been described, the present invention can be applied to a wide variety of machine tools, providing many alternative ways of implementing the invention.

I claim:

1. A machine tool swarf removal apparatus, comprising:
a machine tool having a rotating part directed at a workpiece;
a set of slanted vanes, connected to the rotating part;
the set of slanted vanes positioned over the workpiece and during machine operation the slanted vanes create a force of air on the workpiece strong enough to blow swarf out and away from the workpiece.

2. The machine tool swarf removal apparatus of claim 1, wherein:
the composition of the set of slanted vanes provides them with a stability during high speed rotation to create the required air force on the workpiece.

3. The machine tool swarf removal apparatus of claim 1, further comprising:
an elastomer insert having an inner hub;
the inner hub fits onto the rotating part, attaching the inner hub to the rotating part;
the set of slanted vanes have an outer edge and an inner edge;
the outer edges of the vanes connect to an outer shroud surrounding the swarf removal apparatus; and
the inner edge of the vanes connect to the elastomer insert.

4. The machine tool swarf removal apparatus of claim 3 wherein the machine tool swarf removal apparatus comprises a one-piece injection molded component.

5. The machine tool swarf removal apparatus of claim 3 further comprising grooves cut into the inner hub; and
O-rings fit in the grooves of the inner hub and provide a firm and secure attachment of the machine tool swarf removal apparatus to the rotating part.

6. The machine tool swarf removal apparatus of claim 3 wherein the rotating part directed at the workpiece is a tool holder.

7. The machine tool swarf removal apparatus of claim 6 wherein the design of the tool holder includes the set of slanted vanes, combining the swarf removal apparatus into the design of the tool holder.

8. The machine tool swarf removal apparatus of claim 3 wherein the rotating part directed at the workpiece is a spindle.

9. The machine tool swarf removal apparatus of claim 3 wherein the rotating part directed at the workpiece is an endmill.

10. The machine tool swarf removal apparatus of claim 1 wherein the composition of the set of the slanted vanes is a nonmetallic material having enough firmness to provide the vanes the necessary stability in high speed rotation to provide the necessary air pressure on the workpiece, keeping the workpiece clear of swarf.

11. The machine tool swarf removal apparatus of claim 1 wherein the composition of the set of the slanted vanes is a metal suitable to provide the necessary stability and firmness during high speed rotation to create the necessary air pressure on the workpiece, keeping the workpiece clear of swarf.

12. The machine tool swarf removal apparatus of claim 3 wherein an elastomer material provides the composition of the inner hub giving the inner hub the necessary tight connection between the swarf removal apparatus and the rotating tool part.

13. The machine tool swarf removal apparatus of claim 1 wherein the slanted vanes operate in a machine tool having low-pressure coolant system;
the low-pressure coolant system of the machine tool having a cutting area; and
the slanted vanes, directed at the cutting area, divert coolant to the cutting area.

14. An apparatus for removing swarf from a workpiece during the operation of a machine tool, comprising:
a set of slanted vanes attached to a rotating part of the machine tool;
the rotating part directed at the workpiece; and
during machine operation the rotating part with the attached vanes create a force of air on the workpiece sufficient to clear the workpiece of swarf.

15. The machine tool swarf removal apparatus of claim 14 further comprising an inner hub attached to a rotating part of a machine tool;
the set of slanted vanes attach to the inner hub and extend outwardly from the inner hub.

16. The swarf removal apparatus of claim 15 further comprising;
each of the plurality of vanes having an outer edge; and
the outer edge of the vanes connect to an outer shroud.

17. The swarf removal apparatus of claim 14 wherein:
the rotating part has an outer diameter;
the inner hub has an inner diameter; and
the inner diameter of the inner hub forms an interference fit between the outer diameter of the rotating part and the inner diameter of the inner hub.

18. The swarf removal apparatus of claim 17 wherein the inner hub connects to a machine tool holder;
the connection of the inner hub to the tool holder forms an interference fit between the inner diameter of the inner hub and the outer diameter of the tool holder.

19. The swarf removal apparatus of claim 17 further comprising an elastomer ring attached to the inner diameter of the inner hub;
the elastomer ring creates an interference fit between the inner diameter of the inner hub and the outer diameter of the rotating tool part.

20. A method for keeping a workpiece free of swarf during the operation of a machine tool, comprising:
choosing a rotating part of the machine tool directed at the workpiece;
mounting a set of slanted vanes onto the rotating part;
operating the machine tool; and
keeping the workpiece free of swarf during machine tool operation by a flow of constant and sufficient airflow on the workpiece from the set of slanted vanes on the rotating part.
